(19) United States
(12) Patent Application Publication
(10) Pub. No.: US 2019/0027118 A1
(43) Pub. Date: Jan. 24, 2019

(54) TERMINAL DEVICE AND DISPLAY METHOD

(71) Applicant: Wuhan China Star Optoelectronics Technology Co. Ltd., Wuhan, Hubei (CN)

(72) Inventor: Qingcheng ZUO, Shenzhen, Guangdong (CN)

(73) Assignee: Wuhan China Star Optoelectronics Technology Co., L td., Wuhan, Hubei (CN)

(21) Appl. No.: 15/563,650

(22) PCT Filed: Aug. 18, 2017
(86) PCT No.: PCT/CN2017/098119

§ 371 Date: Oct. 2, 2017

(30) Foreign Application Priority Data
Jul. 24, 2017 (CN) 201710605190.3

(51) Int. Cl. G09G 5/373; G06F 3/01; G06T 3/40

(52) U.S. Cl. CPC G09G 5/373; G09G 2340/0407; G06T 3/40; G06F 3/013

(57) ABSTRACT

A terminal device and a display method are provided. The terminal device includes a proximity sensor, a memory, a controller and a display screen. The proximity sensor is configured to sense a distance from a human eye to the display screen. The memory is configured to store contents to be displayed. The controller is configured to determine a target resolution for the contents to be displayed based on the distance sensed by the proximity sensor, adjust an original resolution of the contents to be displayed to the target resolution to generate target display contents having the target display resolution, and control the display screen to display the target display contents in full screen. The target resolution may be inversely proportional to the distance. Solutions provided conform to the viewing characteristics of the human eye, and so can improve the user experience, and reduce the power consumption of the display screen.

### CROSS-REFERENCE

This application claims the benefit of Chinese Patent Application No. 201710605190.3, entitled “Terminal Device and Display Method”, filed Jul. 24, 2017, the disclosure of which is incorporated herein by reference in its entirety.

### BACKGROUND OF THE DISCLOSURE

### 1. Field of the Disclosure

The present disclosure relates to the field of display, and more particularly to a terminal device and a display method.

### 2. The Related Arts

User's satisfaction with the use of a terminal device is to a large extent determined by display effects of a display screen. Existing display screens are designed without taking into account the characteristics that human eyes have a strong ability to distinguish details of an image placed nearby, but are weak to distinguish the details of an image far away. Typically the image fineness of the display screen would remain unchanged when the distance between the human eyes and the image is changed, which cannot bring a good user experience.

### SUMMARY OF THE DISCLOSURE

In view of the above, this disclosure provides a terminal device and a display method, which can address the problem of a poor viewing experience with the display screen.

A terminal device is disclosed that includes a proximity sensor, a memory, a controller, and a display screen. The proximity sensor is configured to sense a distance from a human eye to the display screen. The memory is configured to store contents to be displayed. The controller is configured to determine a target resolution of the contents to be displayed based on the distance sensed by the proximity sensor and adjust an original resolution of the contents to be displayed to the target resolution, so as to generate target display contents having the target display resolution, and further control the display screen to display the target display contents in full screen (in other words, full-screen display), where the target resolution is inversely proportional to the distance.

The target resolution may be less than a screen resolution of the display screen.

The controller may display the target display contents on the display screen by using image resolution upscaling technology.

In particular, the controller is configured to determine the target resolution associated with the distance based on correspondences between preset distances and target resolutions, and thus generate the target display contents having the target resolution.

In particular, the controller is configured to determine the target resolution associated with the distance based on correspondences between preset distance ranges and target resolutions, and thus generate the target display contents having the target resolution.

A display method is disclosed for use with a terminal device that includes a display screen and a memory storing contents to be displayed. The method includes the following. A distance from a human eye to the display screen is sensed. A target resolution for the contents to be displayed is determined based on the distance and an original resolution of the contents to be displayed is adjusted to the target resolution, so as to generate target display contents with the target display resolution, where the target resolution is inversely proportional to the distance. The target display contents are then full-screen displayed on the display screen.

The target resolution may be less than a screen resolution of the display screen.

In displaying the target display contents in full screen on the display screen, the target display contents may be full-screen displayed on the display screen by using image resolution upscaling technology.

In determining the target resolution for the contents to be displayed based on the distance and adjusting the original resolution of the contents to be displayed to the target resolution, to generate the target display contents having the target display resolution, the target resolution associated with the distance may be determined based on correspondences between preset distance ranges and target resolutions, so as to generate the target display contents having the target resolution.

By the solution of this disclosure, the original resolution of the contents to be displayed can be adjusted to obtain the target display contents based on the distance from the human eye to the display screen, thus the display screen can be controlled to display the target display contents in full screen. Because the target resolution of the target display contents is inversely proportional to the distance, the target resolution can be reduced at a larger distance, while increased at a closer distance, which conforms to the relatively strong ability of human eyes to distinguish details of an image nearby, and the relatively weak ability to distinguish the details of an image far away from the human eyes, which is consistent with ergonomic principles, thus improving the viewing experience. In addition, at a large distance the amount of image data can be reduced by making the target resolution smaller than the screen resolution of the display screen, thus reducing the power consumption of the display screen.

### BRIEF DESCRIPTION OF THE DRAWINGS

In order to better illustrate the technical solutions of embodiments of the disclosure, the accompanying drawings for use with the description of the embodiments will be briefly described below. It will be apparent that the drawings described in the following represent merely some embodiments of the disclosure, and that those of ordinary skill in the art, without performing any creative work, will be able to obtain other drawings from these drawings, in which:

FIG. 1 is a block diagram illustrating a terminal device according to an embodiment of the disclosure.

FIG. 2 is a scenario diagram illustrating displaying of an image by a terminal device according to an embodiment of the disclosure.

FIG. 3 is a flow chart illustrating a display method according to an embodiment of the disclosure.

### DETAILED DESCRIPTION OF THE PREFERRED EMBODIMENTS

The present disclosure will be described in detail below with reference to the accompanying drawings for use with various implementations, to provide a clear and complete description of the technical solutions of the implementations of the disclosure.

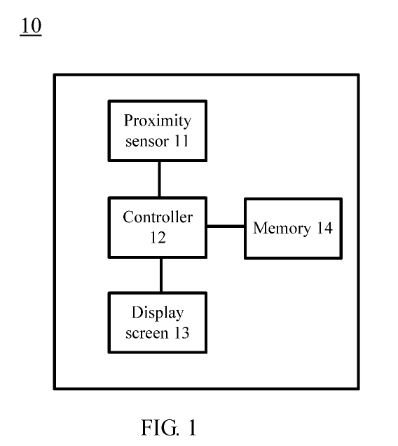

As illustrated in FIG. 1, a terminal device 10 is provided in accordance with an embodiment of the disclosure. The terminal device 10 may include, but not limited to: an integrated electronic product such as a mobile phone, a tablet computer, or a desk-top computer; and a display device having only display functionality such as an advertisement screen or a display device.

As illustrated in FIG. 1, the terminal device 10 includes a proximity sensor 11, a controller 12, a display screen 13, and a memory 14.

The proximity sensor 11 is configured to sense a distance from a human eye to the display screen 13. The memory 14 is configured to store contents to be displayed, which may be the display contents built-in in the terminal device 10, or received from other devices or downloaded from a server and thus stored in the memory 14. The display contents may include but not limited to static images, dynamic videos, and the like.

The controller 12 is configured to: determine a target resolution for the contents to be displayed based on the distance sensed by the proximity sensor 11, and adjust an original resolution of the contents to be displayed to the target resolution, so as to generate target display contents having the target display resolution; and control the display screen to display the target display contents in full screen. The target resolution may be inversely proportional to the distance.

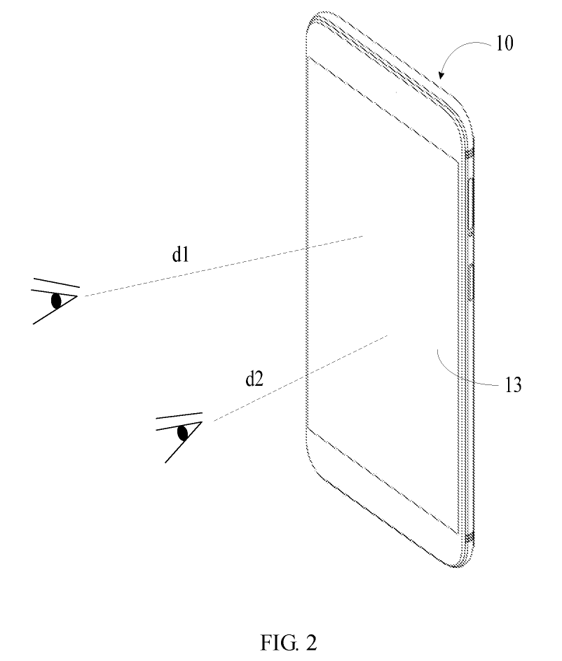

FIG. 2 schematically illustrates a specific application scenario of this embodiment. As illustrated in FIG. 2, the terminal device 10 may be a mobile phone, where the controller 12 and the memory 14 both are built-in in the terminal device 10. The proximity sensor 11 may also be disposed in the terminal device 10. For example, the proximity sensor 11 may be provided underneath the touch panel of the terminal device 10. Two different positions of human eyes are illustrated in FIG. 2. At one position, a distance sensed by the proximity sensor 11 from the human eye to the display screen 13 is d1, while at the other position, a distance sensed by the proximity sensor 11 from the human eye to the display screen 13 is d2, with distance d1 greater than distance d2.

In this embodiment, the controller 12 is configured to control display of the display screen 13. The controller 12 may include, for example, a central processing unit and a display driving module. The controller 12 may receive a distance value sensed by the proximity sensor 11, such as the distance d1 and the distance d2. The controller 12 may also receive the contents to be displayed, having an original resolution, from the memory 14. The controller 12 may process the contents to be displayed based on the distance d1 or d2, and thus adjust the original resolution of the contents to be displayed to the target resolution to obtain the target display contents. The target display contents are the contents finally displayed on the display screen 13.

The target resolution may be a resolution that meets the viewing sharpness requirements of the human eye at a certain distance. The sharpness requirements of the human eye watching an image at a certain distance may be determined by a large amount of experimental data based on ergonomic practice.

Further in this embodiment, the controller 12 can determine the target resolution associated with the distance based on correspondences between preset distances and target resolutions, and thus generate the target display contents having the target resolution. In particular, the controller 12 may set in advance mapping relationships between the preset distances and the target resolutions. When the distance is received, the controller 12 may compare the distance with the preset distances, so when the distance is one of the preset distances, then the controller can determine the target resolution associated with the preset distance (or this distance). In this way, the controller 12 can generate the target display contents having the associated target resolution for each of the distances and further control the display screen 13 to display, thus achieving flexible and real-time image display suitable for use in various occasions.

Alternatively in this embodiment, the controller 12 may determine the target resolution associated with the distance based on correspondences between preset distance ranges and target resolutions, and thus generate the target display contents having the target resolution. In particular, the controller 12 may set in advance mapping relationships between the preset distance ranges and the target resolutions. When receiving the distance, then the controller 12 may determine to which of the preset distance ranges the distance belongs. As such, when the distance falls in one of the preset distance ranges, then the target resolution associated with preset distance range (or this distance) can be determined. For example, when the controller 12 determines that the distance d1 falls in a first preset distance range, then the resolution 720*1080 that is associated with the first preset distance range and can meet the sharpness requirements may serve as the target resolution. Likewise, the controller 12 may determine that the distance d2 falls in a second preset distance range, so that the resolution 1080*1920 that is associated with the second preset distance range and can meet the sharpness requirements may be determined as the target resolution.

For several distances that fall in the same distance range, the controller 12 may maintain the display at the same target resolution, which renders it unnecessary to adjust the image resolution of the display screen 13 for each of the distances, thus avoiding image jitter on the display screen 13, ensuring the viewing experience.

In this embodiment, the target resolution may be inversely proportional to the distance; that is, the less the distance, the higher the target resolution. Thus, it accords with the human eyes' strong ability to distinguish details of an image placed nearby, as well as the weak ability to distinguish details of an image far off, so that the viewing experience can be improved. For example, when distance d1 is greater than distance d2, then the target resolution 720*1080 would be less than the target resolution 1080*1920.

More particularly, at more distance, the amount of image data can be reduced by making the target resolution smaller than the screen resolution of the display screen 13, thus reducing power consumption of the display screen 13.

As described above, the terminal device 10 of this embodiment can adjust the original resolution of the contents to be displayed to obtain the target display contents based on the distance from the human eye to the display screen 13, and further control the display screen 13 to display the target display contents in full screen. Because the target resolution of the target display contents is inversely proportional to the distance, the target resolution may become less at a larger distance, while become more at a closer distance, which conforms to the human eyes' relatively strong ability to distinguish details of an image placed nearby, as well as the relatively weak ability to distinguish the details of an image far off, and which is consistent with ergonomic principles, thus improving the viewing experience. In addition, at a larger distance, the amount of image data can be reduced by making the target resolution smaller than the screen resolution of the display screen, thus reducing the power consumption of the display screen.

In this embodiment, the original resolution of the contents to be displayed may be greater than, equal to, or smaller than the screen resolution of the display screen 13. Typically, the original resolution may be smaller than or equal to the screen resolution of the display screen 13; that is, the target resolution can be less than the screen resolution of the display screen 13. Thus, the controller 12 only needs to transmit the target display contents having a resolution smaller than the screen resolution to the display screen 13, so that the amount of the displayed image data can become still smaller, thereby further reducing the power consumption of the display screen 13.

In this embodiment, the controller 12 typically may use upscaling (image resolution upscaling) technology to achieve full-screen display on the display screen 13. For example, the target display contents with a target resolution 720*1080 may be full-screen displayed on the display screen 13 having a screen resolution of 1440*2560, by using 2.0 times upscaling. Alternatively, the target display contents with the target resolution 1080*1920 may be full-screen displayed on the display screen 13 having the screen resolution of 1440*2560 by using 1.3 times upscaling. The upscaling technology features fast and highly efficient data processing, as well as maturity for use. In other embodiments, the full-screen display may also be implemented in other ways.

In this embodiment, the proximity sensor 11 may be an infrared sensor. An infrared signal of the infrared sensor is strongly capable of penetration and has little signal distortion, hence conducive to precise measurement of the distance. In other embodiments, the proximity sensor 11 may also be other sensing devices capable of determining the distance.

The terminal device according to the embodiments of the disclosure has been described above in detail. Hereinbelow the display method disclosed by the embodiments of the disclosure will be described.

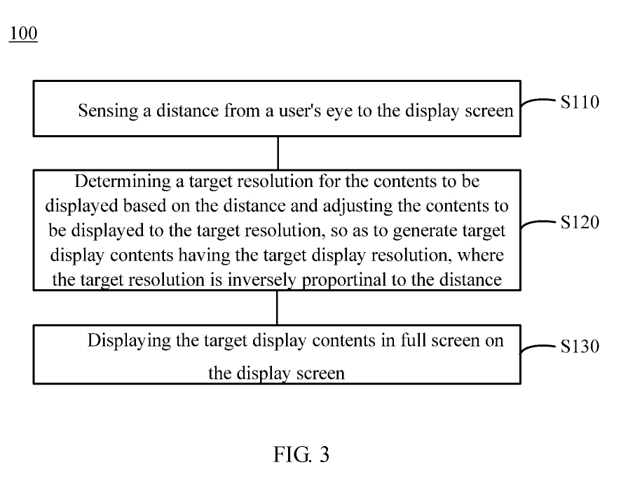

As illustrated in FIG. 3, a display method 100 for displaying an image on a display screen of a terminal device is provided according to an embodiment of the disclosure. The terminal device includes a memory storing contents to be displayed. The terminal device may be the terminal device 10 described in the above embodiments. The display screen may be the display screen 13 of the terminal device 10. The memory may be the memory 14 described above. The display method 100 may include the following operations.

At S110, a distance from a human eye to the display screen is sensed.

At S120, a target resolution for the contents to be displayed is determined based on the distance, and an original resolution of the contents to be displayed is adjusted to the target resolution, so as to generate target display contents having the target resolution, where the target resolution is inversely proportional to the distance.

At S130, the target display contents are full-screen displayed on the display screen.

In particular, as illustrated in FIG. 1 and FIG. 2, at S110 the proximity sensor 10 may be used to sense the distance. At S120, the controller 12 may be used to receive the contents to be displayed and the distance, and further perform the operation of generating the target display contents. The target resolution may be a resolution that meets the viewing sharpness requirements of the human eye at a certain distance. The sharpness requirements of the human eye watching an image at a certain distance may be determined by a large amount of experimental data based on ergonomic practice. At S130, the controller 12 can be used to control the display screen 13 to display the target display contents in full screen.

It will be appreciated that the various executive subjects in the display method 100 may correspond to various respective modules of the terminal device 10, and the corresponding flows of the display method 100 can be implemented by the above and other operations and/or functions of the various respective modules in the terminal device 10, which, are not to be detailed herein, for the sake of brevity.

In particular, at a larger distance, the amount of image data can be reduced by making the target resolution smaller than the screen resolution of the display screen 13, thereby reducing the power consumption of the display screen 13.

By the display method 100 provided by this embodiment, the original resolution of the contents to be displayed can be adjusted to obtain the target display contents based on the distance from the human eye to the display screen 13, and further the display screen 13 can be controlled to display the target display contents in full screen. Because the target resolution of the target display contents is inversely proportional to the distance, the target resolution can become less at a larger distance, while more at a closer distance, which conforms to the human eyes' relatively strong ability to distinguish details of an image placed nearby, as well as relatively weak ability to distinguish the details of an image far off, and which is consistent with ergonomic principles, thus improving the viewing experience. In addition, at a larger distance, the amount of image data can be reduced by making the target resolution smaller than the screen resolution of the display screen, thus reducing the power consumption of the display screen.

In the display method 100 of this embodiment, the original resolution of the contents to be displayed may be greater than, equal to, or smaller than the screen resolution of the display screen. Typically, the original resolution may be smaller than or equal to the screen resolution of the display screen; that is, the target resolution may be less than the screen resolution of the display screen. Thus, only the target display contents having a resolution smaller than the screen resolution would be needed to transmit to the display screen, so that the amount of the displayed image data can become still smaller, thereby further reducing the power consumption of the display screen.

Further, at S130, displaying the target display contents on the display screen in full screen may include: displaying the target display contents on the display screen in full screen by using upscaling technology. For example, the target display contents with a target resolution 720*1080 may be full-screen displayed on the display screen having a screen resolution 1440*2560, by using 2.0 times upscaling. Alternatively, the target display contents with a target resolution 1080*1920 may be full-screen displayed on the display screen having the screen resolution 1440*2560 by using 1.3 times upscaling. The upscaling technology features fast and highly efficient data processing, as well as maturity for use. In other embodiments, the full-screen display may also be implemented in other ways.

Further, at S120, determining the target resolution for the contents to be displayed based on the distance and adjusting the original resolution of the contents to be displayed to the target resolution so as to generate the target display contents having the target resolution may include:

determining the target resolution associated with the distance based on correspondences between preset distances and target resolutions, and thus generating the target display contents having the target resolution.

In particular, the controller 12 may determine the target resolution associated with the distance based on the correspondences between the preset distances and the target resolutions and thus generate the target display contents having the target resolution. In particular, the controller 12 may set in advance the mapping relationships between the preset distances and the target resolutions. When the distance is received, the controller 12 may compare the distance against the preset distances, so when the distance is one of the preset distances, then the controller 12 can determine the target resolution associated with the preset distance (or this distance). In this way, the controller 12 can generate the target display contents having the associated target resolution for each of the distances and further control the display screen 13 to display, thus achieving flexible and real-time image display suitable for use in various occasions.

Alternatively, determining the target resolution for the contents to be displayed based on the distance and adjusting the original resolution of the contents to be displayed to the target resolution, to generate the target display contents having the target resolution in S120 may include:

determining the target resolution associated with the distance based on correspondences between preset distance ranges and target resolutions, and thus generating the target display contents having the target resolution.

In particular, the controller 12 may determine the target resolution associated with the distance based on the correspondences between the preset distance ranges and the target resolutions, and thus generate the target display contents having the target resolution. In particular, the controller 12 may set in advance the mapping relationships between the preset distance ranges and the target resolutions. When receiving the distance, the controller 12 may determine to which one of the preset distance ranges the distance belongs. As such, when the distance falls in one of the preset distance ranges, then the target resolution associated with preset distance range (or this distance) can be determined. For example, when the controller 12 determines that the distance d1 falls in a first preset distance range, then resolution 720*1080 that is associated with the first preset distance range and can meet the sharpness requirements may serve as the target resolution. Likewise, the controller 12 may determine that the distance d2 falls in a second preset distance range so that the resolution 1080*1920 that is associated with the second preset distance range and can meet the sharpness requirements may be determined as the target resolution. For several distances that fall in the same distance range, the controller 12 may maintain the display at the same target resolution, which renders it unnecessary to adjust the image resolution of the display screen 13 for each of the distances, thus avoiding the screen jitter on the display screen 13, ensuring the viewing experience.

The foregoing description merely depicts some specific embodiments of the disclosure, which however are not intended to limit the disclosure. Any modifications, equivalent substitutions, or improvements made thereto without departing from the spirit and principle of the disclosure shall all be encompassed within the protection of the disclosure. Therefore, the scope of protection of this application shall be subject to the scope of protection of the claims.

1. A terminal device, comprising:
a proximity sensor, a memory, a controller, and a display screen; wherein
the proximity sensor is configured to sense a distance from a human eye to the display screen;
the memory is configured to store contents to be displayed; and
the controller is configured to: determine a target resolution for the contents to be displayed based on the distance sensed by the proximity sensor and adjust an original resolution of the contents to be displayed to the target resolution to generate target display contents having the target resolution; and control the display screen to display the target display contents in full screen, where the target resolution is inversely proportional to the distance.

2. The terminal device of claim 1, wherein the target resolution is less than a screen resolution of the display screen.

3. The terminal device of claim 2, wherein the controller uses image resolution upscaling technology to display the target display contents on the display screen in full screen.

4. The terminal device of claim 1, wherein the controller is configured to determine the target resolution associated with the distance based on correspondences between preset distances and target resolutions and thus generate the target display contents having the target resolution.

5. The terminal device of claim 1, wherein the controller is configured to determine the target resolution associated with the distance based on correspondences between preset distance ranges and target resolutions and thus generate the target display contents having the target resolution.

6. A display method for displaying an image on a display screen of a terminal device that comprises a memory storing contents to be displayed, the display method comprising:
sensing a distance from a human eye to the display screen;
determining a target resolution for the contents to be displayed based on the distance and adjusting an original resolution of the contents to be displayed to the target resolution to generate target display contents having the target resolution, where the target resolution is inversely proportional to the distance; and
displaying the target display contents on the display screen in full screen.

7. The display method of claim 6, wherein the target resolution is less than a screen resolution of the display screen.

8. The display method of claim 7, wherein displaying the target display contents in full screen on the display screen comprises: displaying the target display contents in full screen on the display screen by using image resolution upscaling technology.

9. The display method of claim 6, wherein determining the target resolution of the contents to be displayed based on the distance and adjusting the original resolution of the contents to be displayed to the target resolution, to generate the target display contents having the target resolution comprises:
determining the target resolution associated with the distance based on correspondences between preset distances and target resolutions and thus generating the target display contents having the target resolution.

10. The display method of claim 6, wherein determining the target resolution of the contents to be displayed based on the distance and adjusting the original resolution of the contents to be displayed to the target resolution, to generate the target display contents having the target display resolution comprises:
determining the target resolution associated with the distance based on correspondences between preset distance ranges and target resolutions and thus generating the target display contents having the target resolution.

11. The display method of claim 6, wherein the display contents are received from other devices.

12. The display method of claim 6, wherein the display contents are downloaded from a server and stored in the memory.

13. The display method of claim 6, wherein the display contents include static images and dynamic videos.

14. The display method of claim 10, wherein for a plurality of distances falling in the same distance range, the display is maintained at the same target resolution.

15. The display method of claim 6, wherein the proximity sensor is an infrared sensor.

16. The terminal device of claim 1, wherein the display contents are received from other devices.

17. The terminal device of claim 1, wherein the display contents are downloaded from a server and stored in the memory.

18. The terminal device of claim 1, wherein the display contents include static images and dynamic videos.

19. The terminal device of claim 5, wherein for a plurality of distances falling in the same distance range, the controller is configured to maintain the display at the same target resolution.

20. The terminal device of claim 1, wherein the proximity sensor is an infrared sensor.
